(19) United States
(12) Patent Application Publication
(10) Pub. No.: US 2025/0098643 A1
(43) Pub. Date: Mar. 27, 2025

(54) ANALYSIS SUPPORTING APPARATUS, ANALYSIS SUPPORTING METHOD, AND COMPUTER PROGRAM

(71) Applicant: Central Institute for Experimental Medicine and Life Science, Kawasaki, shi, Kanagawa (JP)

(72) Inventors: Terumi YURIMOTO, Kawasaki-shi (JP); Takashi INOUE, Kawasaki-shi (JP); Erika SASAKI, Kawasaki-shi (JP); Atsushi IRIKI, Wako-shi (JP); Yumiko YAMAZAKI, Wako-shi (JP)

(21) Appl. No.: 18/729,775

(22) PCT Filed: Jan. 19, 2023
(86) PCT No.: PCT/JP2023/001518

§ 371 Date: Jul. 17, 2024

(30) Foreign Application Priority Data
Jan. 21, 2022 (JP) 2022-008052

(51) Int. Cl. A01K 29/00

(52) U.S. Cl. CPC A01K 29/005

(57) ABSTRACT

An analysis supporting apparatus includes an individual tracking unit configured to acquire behavior history information indicating a behavior history of each individual of a target animal, which is an animal to be analyzed, based of at least one piece of information among image information obtained by an image sensor that acquires an image of the target animal, acoustic information obtained by an acoustic sensor that acquires a sound emitted by the target animal, information obtained from a wearable sensor attached to the target animal, and information obtained from a terminal apparatus.

### TECHNICAL FIELD

The present invention relates to a technology for analyzing animal behavior in a predetermined area.

Priority is claimed on Japanese Patent Application No. 2022-008052, filed Jan. 21, 2022, the content of which is incorporated herein by reference.

### BACKGROUND ART

The common marmoset (Callithrix jacchus) is an animal with a highly developed brain. For this reason, the common marmoset is often used in neuroscience experiments (for example, refer to Patent Document 1). For example, the common marmoset is used to evaluate a brain function through instrumental problems. More specifically, evaluations of cognitive function and motivation have been reported in acute experimental models of depression and schizophrenia in marmosets treated with drug administration.

The common marmoset is also known to exhibit social behavior similar to that of humans. For example, the common marmoset is characterized by familial herd formation and food sharing behavior. Because each individual common marmoset has its own individuality and is social, when the behavior of the common marmoset is analyzed, it is necessary to track each individual and evaluate the behavior thereof for a plurality of individuals living together. There is no system that can measure changes in behavior over a lifetime, including evaluation of social behavior.

### CITATION LIST

### Literature

### [Patent Literature 1]

Japanese Unexamined Patent Application, First Publication No. 2008-9641

### SUMMARY OF INVENTION

### Technical Problem

However, it is difficult to evaluate behavior by using only a task problem such as a cognitive function evaluation problem that has been conventionally performed. Such problems are common not only when the animal to be evaluated is a common marmoset, but also when other types of animals are used.

In view of the circumstances described above, the present invention has an object of providing a technology that makes it possible to more appropriately observe animal behavior, including social behavior of animals, over time and evaluate changes in behavior.

### Solution to Problem

According to one aspect of the present invention, an analysis supporting apparatus includes an individual tracking unit configured to acquire behavior history information indicating a behavior history of each individual of a target animal, which is an animal to be analyzed, based on at least one piece of information among image information obtained by an image sensor that acquires an image of the target animal, acoustic information obtained by an acoustic sensor that acquires a sound emitted by the target animal, information obtained from a wearable sensor attached to the target animal, and information obtained from a terminal apparatus.

According to the aspect of the present invention, in the analysis supporting apparatus described above, the wearable sensor may be an acceleration sensor that obtains acceleration information of the target animal to which the wearable sensor is attached.

According to the aspect of the present invention, in the analysis supporting apparatus described above, the individual tracking unit may use individual information stored in a storage unit to identify individuals in the used information, and to acquire the behavior history information for each identified individual.

According to the aspect of the present invention, in the analysis supporting apparatus described above, information may be presented to the target animal using a terminal apparatus and the behavior history information for each identified individual may be acquired.

According to another aspect of the present invention, an analysis supporting method includes an acquisition step of acquiring at least one piece of information among image information obtained by an image sensor that acquires an image of a target animal, which is an animal to be analyzed, acoustic information obtained by an acoustic sensor that acquires a sound emitted by the target animal, information obtained from a wearable sensor attached to the target animal, and information obtained from a terminal apparatus, and an individual tracking step of acquiring behavior history information indicating a behavior history of each individual of the target animal based on the acquired information of the target animal.

According to still another aspect of the present invention, there is a computer program for causing a computer to function as the analysis supporting apparatus described above.

### Advantageous Effects of Invention

According to the present invention, it is possible to more appropriately observe animal behavior, including animal social behavior, over time and evaluate changes in behavior.

### BRIEF DESCRIPTION OF DRAWINGS

FIG. 1 is a schematic block diagram which shows a system configuration of an analysis supporting system 100 of the present invention.

FIG. 2 is a diagram which shows a specific example of a functional configuration of an analysis supporting apparatus 70.

FIG. 3 is a diagram which shows a specific example of a configuration of a cage 10.

FIG. 4A is an example of a diagram which has analyzed animal behavior using the analysis supporting apparatus 70.

FIG. 4B is an example of a diagram which has analyzed animal behavior using the analysis supporting apparatus 70.

### DESCRIPTION OF EMBODIMENTS

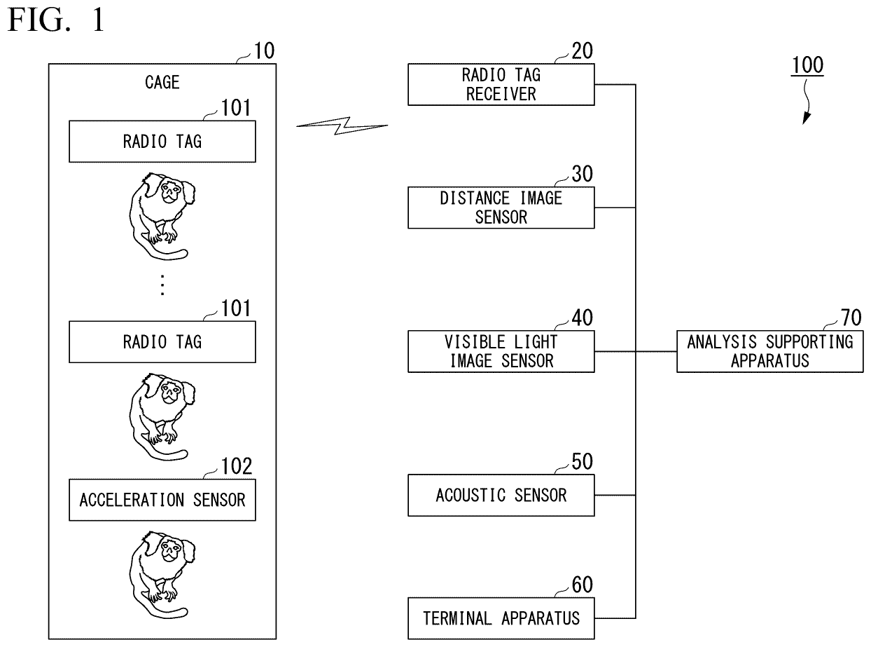

Hereinafter, a specific configuration example of the present invention will be described with reference to the drawings. FIG. 1 is a schematic block diagram which shows a system configuration of an analysis supporting system 100 of the present invention. The analysis supporting system 100 collects information regarding a behavior of an animal to be analyzed (hereinafter referred to as a “target animal”), and supports an analysis of the target animal based on the collected information. The target animal may be any animal. The target animal may be, for example, a mammal, a bird, a reptile, an amphibian, or an invertebrate animal including an insect. In the following description, an example will be described in which the common marmoset is used as the target animal. In the analysis supporting system 100, the target animal is kept in a cage 10.

The analysis supporting system 100 includes a plurality of radio tags 101, a radio tag receiver 20, a distance image sensor 30, a visible light image sensor 40, an acoustic sensor 50, a terminal apparatus 60, and an analysis supporting apparatus 70. The radio tag 101 and the radio tag receiver 20 transmit and receive data by performing short-range wireless communication. The distance image sensor 30, the visible light image sensor 40, the acoustic sensor 50, the terminal apparatus 60, and the analysis supporting apparatus 70 perform data communication through wireless or wired communication.

The radio tag 101 is attached to a target animal. The radio tag 101 may be non-invasively attached to the target animal, or may be implanted into a body of the target animal. When the radio tag 101 is attached non-invasively, it may be attached to a device such as a collar or a bracelet, and such a device may be attached to the target animal. When the radio tag 101 is implanted in the body, it may be implanted, for example, under the skin of the target animal. Each radio tag 101 stores identification information different from that of other radio tags 101. When the radio tag 101 approaches to within a predetermined distance from the radio tag receiver 20, the radio tag 101 transmits identification information to the radio tag receiver 20. Based on this identification information, it is possible to identify which target animal has approached the radio tag receiver 20 (individual identification).

The radio tag receiver 20 wirelessly communicates with the radio tag 101 positioned within the predetermined distance. The radio tag receiver 20 outputs the identification information received from the radio tag 101 to the analysis supporting apparatus 70. When outputting the identification information, the radio tag receiver 20 may output the identification information together with additional information. The additional information may be, for example, a date and time when the identification information has been received, identification information indicating the radio tag receiver 20 (device identification information), or other pieces of information.

The acceleration sensor 102 is attached to the target animal alone or in combination with the radio tag 101. The acceleration sensor 102 may be attached to the target animal non-invasively, or may be implanted within the body of the target animal. When the acceleration sensor 102 is attached non-invasively, it may be provided on a device such as a collar, a bracelet, or a belly band, and such a device may be attached to the target animal. When the acceleration sensor 102 is implanted in the body, it may be implanted, for example, under the skin of the target animal. Each acceleration sensor 102 stores identification information different from other acceleration sensors 102. Each acceleration sensor 102 stores acceleration information. Based on this acceleration information, it is possible to record which target animal has made what movements and when it has made the movement. The acceleration sensor may be configured as a wearable sensor. Moreover, instead of or in addition to the acceleration sensor, a sensor that obtains physiological information of the target animal or a barometer that measures an atmospheric pressure of a space where the target animal is present may be used as a wearable sensor.

The distance image sensor 30 captures distance images in a short cycle. The short cycle is a cycle that is short enough to track a movement of the target animal within the cage 10. The short cycle may be, for example, about 0.01 seconds, about 0.1 seconds, or about 1 second. The distance image sensor 30 may be configured using, for example, a device using laser light, such as light detection and ranging (LiDAR), or may be configured using another device.

The distance image sensor 30 is installed to image the target animal within the cage 10. A plurality of distance image sensors 30 may be used. For example, the entire cage 10 may be imaged to have fewer blind spots by installing the plurality of distance image sensors 30 so as to capture images in different fields of view. Information regarding the distance image captured by the distance image sensor 30 is output to the analysis supporting apparatus 70.

The visible light image sensor 40 captures visible light images in a short cycle. The short cycle is a cycle that is short enough to track the movement of the target animal within the cage 10. The short cycle may be, for example, about 0.01 seconds, about 0.1seconds, or about 1 second. An imaging cycle in the distance image sensor 30 and an imaging cycle in the visible light image sensor 40 may be the same as or different from each other. Moreover, instead of the visible light image sensor 40, other types of image sensors such as an infrared image sensor or a thermography sensor may be used.

The visible light image sensor 40 may be configured using a so-called image sensor such as a CMOS sensor. The visible light image sensor 40 is installed to image the target animal inside the cage 10. A plurality of visible light image sensors 40 may be used. For example, the entire cage 10 may be imaged to have fewer blind spots by installing the plurality of visible light image sensors 40 so as to capture images in different fields of view. A position where the distance image sensor 30 is installed and a position where the visible light image sensor 40 is installed may be the same as or different from each other. Information regarding the visible light image captured by the visible light image sensor 40 is output to the analysis supporting apparatus 70.

The acoustic sensor 50 acquires surrounding acoustic information. The acoustic sensor 50 is configured using, for example, a microphone. The acoustic sensor 50 is installed to acquire sounds emitted by the target animal in the cage 10 (for example, cry of a target animal). A plurality of acoustic sensors 50 may be used. For example, by installing the plurality of acoustic sensors 50 so as to acquire sounds at different positions, a configuration may be provided so that more sounds can be acquired throughout the cage 10 and a position of a sound source can be roughly specified. Information regarding the sounds acquired by the acoustic sensor 50 is output to the analysis supporting apparatus 70.

The terminal apparatus 60 is an information processing device that has a user interface for a target animal. The terminal apparatus 60 may include, for example, a display device and an input device. The display device and the input device may be configured as a touch panel device. The terminal apparatus 60 performs a test on the target animal by displaying an image on a display according to a predetermined rule. For example, the terminal apparatus 60 may perform a test on the target animal by operating as follows. First, a trigger image is displayed on a touch panel device.

The trigger image is an image displayed in an initial state before a test for a target animal is started. The test is started in response to the target animal performing an action that satisfies a predetermined condition in response to the display of the trigger image. For example, the predetermined condition may be that the target animal is in contact with a touch panel. In this case, the trigger image displayed on the touch panel may be an image that is likely to interest the target animal and motivate it to touch it. Specifically, an image of an animal of the same species as the target animal may be used as the trigger image.

As in the present embodiment, when the target animal is a common marmoset, an image of a common marmoset or an image of an animal of a species similar to the common marmoset may be used. Moreover, an image of the target animal's favorite food may be used as the trigger image. Note that the predetermined condition does not need to be limited to the target animal being in contact with the touch panel. For example, the predetermined condition may be that the target animal has approached to within a predetermined distance from the touch panel, or that the target animal invades a cage in which the terminal apparatus 60 is installed.

When the predetermined condition described above is satisfied while the trigger image is displayed (for example, when the target animal touches the touch panel on which the trigger image is displayed), the terminal apparatus 60 performs a task. The number of tasks to be performed may be one type or one of a plurality of types. For example, any one of the following three types of tasks (tests) may be performed.

Task 1: A task in which a white circular image is displayed on the touch panel and a target animal attempts to touch the touch panel

Task 2: A task in which one of a plurality of shapes (for example, a rectangle, a triangle, and a star shape) is randomly selected on the touch panel and displayed in white, and the target animal attempts to touch the touch panel

Task 3: A task in which one color to be used for display is randomly selected from among a plurality of colors (for example, blue, white, red, yellow, and black), this color is used to display a predetermined shape (for example, a circle), and the target animal attempts to touch the touch panel

In any task, when the target animal completes the task (for example, when the target animal has touched the touch panel according to the tasks 1 to 3), the terminal apparatus 60 provides the target animal with a substance with high preference for the target animal. A specific example of the substance with high preference is, for example, a liquid reward (for example, MediDrop Sucralose, ClearH2O). The substance with high preference is not limited to liquids, and may be a solid or gas. The substance with high preference may be a substance that the target animal can eat or drink, or it may be a substance that is not drinkable or edible (for example, Actinidia for cats). For example, the terminal apparatus 60 may output a substance such as a liquid reward from a feeding device 121 that is communicatively connected to the terminal apparatus 60 by controlling the feeding device 121.

Each task is, for example, carried out for six consecutive days, and carried out in order of Tasks 1, 2, and 3. For example, first, Task 1 is carried out for six consecutive days, Task 2 is next carried out for six consecutive days, and then Task 3 is carried out for six consecutive days.

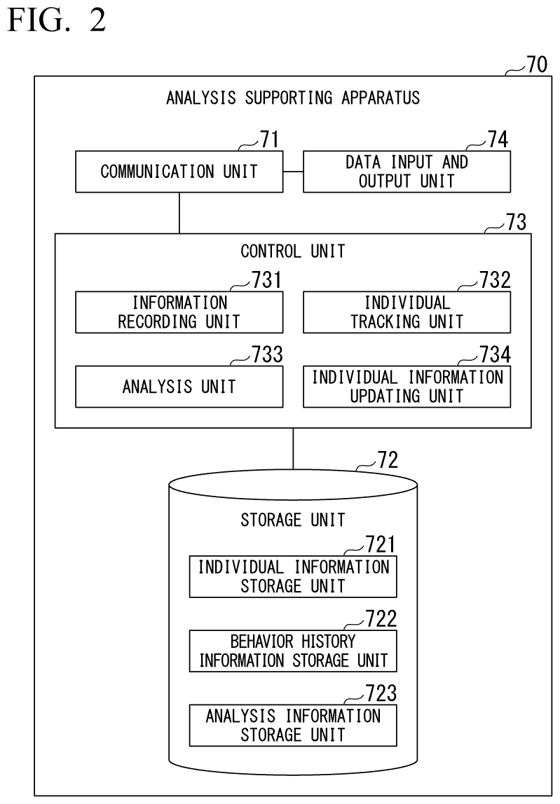

FIG. 2 is a diagram which shows a specific example of a functional configuration of the analysis supporting apparatus 70. The analysis supporting apparatus 70 is configured using a communicative information device. The analysis supporting apparatus 70 may be configured using, for example, an information processing device such as a personal computer, a server device, or a cloud system. The analysis supporting apparatus 70 includes a communication unit 71, a storage unit 72, and a control unit 73.

The communication unit 71 is configured using a communication interface. The communication unit 71 performs data communication with other devices (for example, the radio tag receiver 20, the distance image sensor 30, the visible light image sensor 40, the acoustic sensor 50, and the terminal apparatus 60). The communication unit 71 further takes in data from the acceleration sensor 102 via a data input and output unit 74.

The storage unit 72 is configured using a storage device such as a magnetic hard disk device or a semiconductor storage device. The storage unit 72 functions as an individual information storage unit 721, a behavior history information storage unit 722, and an analysis information storage unit 723.

The individual information storage unit 721 stores information used to identify each individual of the target animal (hereinafter referred to as “individual information”). The individual identification information may be configured using a plurality of types of information. The individual information may be, for example, identification information stored in the radio tag 101 attached to each target animal. The individual information may be, for example, information regarding a face image of each target animal. The information regarding the face image may be the face image itself, or may be information indicating a feature amount extracted from the face image captured in advance.

The individual information may be information regarding a body image of each target animal. The information regarding a body image may be the body image itself, or may be information indicating a feature amount extracted from the body image captured in advance. More specifically, a feature amount indicating a body pattern may be used as the individual information. The individual information may be, for example, a trained model obtained by performing learning processing such as machine learning or deep learning using images of a plurality of target animals. In addition, any piece of information that can identify an individual in the target image based on an output of a device such as the radio tag receiver 20, the distance image sensor 30, the visible light image sensor 40, the acoustic sensor 50, the acceleration sensor 102, or the like may also be used as the individual information. Moreover, all of these sensors are not essential, and may be used in combination as appropriate depending on an object to be observed.

The behavior history information storage unit 722 stores information indicating the behavior history of each individual of the target animal (hereinafter referred to as “behavior history information”). The behavior history information may be, for example, information indicating a result (for example, a movement trajectory) of collecting position information of each individual (for example, spatial coordinates) at a predetermined cycle. The behavior history information may be, for example, information indicating an amount of movement of each individual for each predetermined period. The behavior history information may be, for example, information in which a date and time when a cry of a marmoset has been acquired by the acoustic sensor 50 is associated with a type of the acquired cry. The behavior history information may be, for example, a set of results of the tasks performed by the terminal apparatus 60 and information indicating a date and time of the performance. The behavior history information may be, for example, a set of acceleration information of each individual over time, acquired by the acceleration sensor 102. The behavior history information may be obtained based on, for example, information obtained from the terminal apparatus 60 (for example, a result of a test) as an indication of these pieces of information.

The analysis information storage unit 723 stores information (hereinafter referred to as “analysis information”) obtained by performing an analysis using the behavior history information. The analysis information may be obtained, for example, by processing of the control unit 73 of the analysis supporting apparatus 70. The analysis information may be, for example, information indicating a preference of a place of each target animal. The analysis information may be, for example, information indicating statistical values and history of inter-individual distances for each combination of target animals. The analysis information may be, for example, information indicating a detection history of specific actions in each target animal. The specific actions are one or more specific actions determined in advance. The specific actions may include, for example, grooming, mating, play, an action of a parent feeding a child, and the like.

The control unit 73 is configured using a processor such as a central processing unit (CPU) and a memory. The control unit 73 functions as an information recording unit 731, an individual tracking unit 732, an analysis unit 733, and an individual information updating unit 734 when the processor executes a program. Note that all or part of functions of the control unit 73 may be realized using hardware such as an application specific integrated circuit (ASIC), a programmable logic device (PLD), or a field programmable gate array (FPGA). The program may be recorded on a computer-readable recording medium. Computer-readable recording media include portable media such as flexible disks, magneto-optical disks, ROMs, CD-ROMs, semiconductor storage devices (such as SSDs: Solid State Drives), and storage devices such as hard disks or semiconductor storage devices built into a computer system. The program may be transmitted via a telecommunications line. Note that, depending on a processing capacity of the processor, a graphic processing unit (GPU) may be added to increase an image processing capacity.

The information recording unit 731 acquires behavior history information and records it in the behavior history information storage unit 722 based on information output from the radio tag receiver 20, the distance image sensor 30, the visible light image sensor 40, the acoustic sensor 50, the terminal apparatus 60, the data input and output unit 74. For example, when identification information of the radio tag 101 is acquired from the radio tag receiver 20, the information recording unit 731 associates a date and time when the identification information has been acquired with information indicating an individual according to the acquired identification information and records results of the association as behavior history information. For example, the information recording unit 731 may record a distance image or a visible light image in a predetermined cycle as behavior history information. The information recording unit 731 may record, for example, acoustic information output from the acoustic sensor 50 as behavior history information. Specifically, the information recording unit 731 may detect the cry of a marmoset by performing audio recognition processing, and record a date and time when the cry has been acquired and a type of the acquired cry (for example, information indicating a type of emotion of the marmoset) in association with each other. The information recording unit 731 may record, for example, results of the tasks performed by the terminal apparatus 60 and information indicating a date and time of the performance. The information recording unit 731 may record, for example, acceleration information of each individual obtained through the data input and output unit 74, together with date and time information.

The individual tracking unit 732 uses either or both of a distance image output from the distance image sensor 30 and a visible light image output from the visible light image sensor 40 to track the position (spatial coordinates) of each individual of the target animal. For example, the individual tracking unit 732 may operate as follows.

First, the individual tracking unit 732 detects the position of the target animal on an image. This detection may be performed, for example, by pattern matching using image patterns of the target animal, may be performed using a trained model obtained by performing learning processing using an image of the target animal in advance, or may be performed in other manners. Next, the individual tracking unit 732 acquires three-dimensional coordinates corresponding to the position on the image based on camera parameters. The individual tracking unit 732 uses the individual information stored in the individual information storage unit 721 to identify each individual of the target animal positioned at the three-dimensional coordinates. At this time, it is desirable to use individual information related to the image instead of the identification information of the radio tag 101. Furthermore, the individual tracking unit 732 can record and analyze a behavior of each individual in more detail by using the acceleration information of each individual obtained from the acceleration sensor 102.

By repeatedly executing such processing at a predetermined cycle (for example, 100 milliseconds, 1 second, or the like), it becomes possible to track the spatial coordinates of the positions of a plurality of target animals. The individual tracking unit 732 records information obtained through such processing in the behavior history information storage unit 722. The individual tracking unit 732 may estimate the amount of movement of each individual based on a result of the tracking. In this case, the individual tracking unit 732 may record the estimated amount of movement in the behavior history information storage unit 722.

The analysis unit 733 acquires analysis information by performing analysis processing based on one or more pieces of information output from each device of the radio tag receiver 20, the distance image sensor 30, the visible light image sensor 40, the acoustic sensor 50, the terminal apparatus 60, and the acceleration sensor 102 and information recorded in the behavior history information storage unit 722. The analysis unit 733 records the acquired analysis information in the analysis information storage unit 723.

The analysis unit 733 may, for example, analyze the preference of a place of each target animal. For example, based on a positional history of each target animal, when a length of time each target animal has been in one place and a frequency of being positioned in a specific place are acquired, and these pieces of information meet a predetermined condition, this position may be analyzed as a position with high preference.

The analysis unit 733 may acquire, for example, information indicating a statistic value and history of inter-individual distances for each combination of target animals based on the history of the position of each target animal. The analysis unit 733 may detect, for example, a specific action in each target animal based on one or more of a distance image, a visible light image, and acoustic information. Detection of such a specific action is performed, for example, using a trained model obtained by performing machine learning or deep learning in advance using one or more of a distance image, a visible light image, and acoustic information. The analysis unit 733 may acquire the detection history of a specific action in each target animal.

As an example of detecting such a specific action, a trained model using a visible light image and/or acoustic information may be used to detect grooming behavior of a specific individual, voice data, and a frequency or a preference of voice communication between specific individuals.

The individual information updating unit 734 updates the individual information recorded in the individual information storage unit 721 at a predetermined timing. The predetermined timing may be determined in advance according to a growth of each individual, or may be determined at a predetermined cycle regardless of the growth of each individual. For example, when the target animal is an animal within a predetermined period of time since its birth, the individual information may be updated at a shorter cycle. On the other hand, when the target animal is an animal that has passed a predetermined period of time since its birth, the individual information may be updated at a relatively longer cycle. The individual information is updated using, for example, information (for example, a face image) that is identified as information corresponding to each individual among the captured distance image and visible light image. By updating in this manner, it becomes possible to identify each individual with high accuracy even if an appearance of each individual changes due to the growth, aging, or the like.

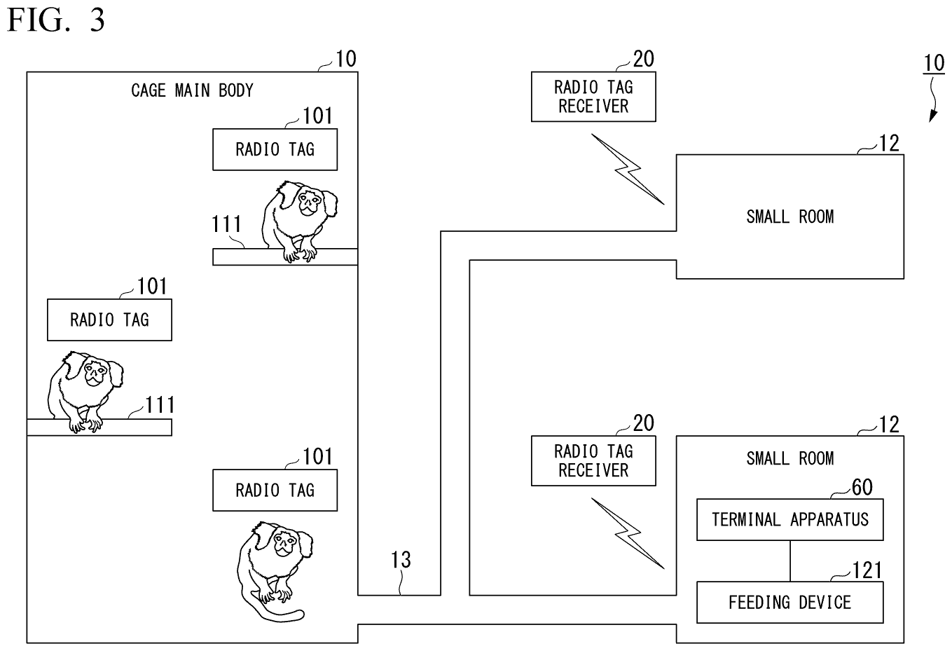

FIG. 3 is a diagram which shows a specific example of a configuration of the cage 10. The cage 10 has a cage main body 11, one or more small rooms 12, and a passage 13. The cage main body 11 is provided with a facility for one or more target animals to live in. The cage body 11 may be provided with a step 111, for example, at a location higher than a floor of the cage body 11. Moreover, in FIG. 3, the cage main body 11 and the small room 12 are configured to be connected by the passage 13, but the small room 12, instead of the passage 13, may be configured to be directly connected to the cage main body 11.

Each small room 12 is provided with a radio tag receiver 20, a terminal apparatus 60, and a feeding device 121. It is desirable that the radio tag receiver 20 is configured to be able to receive identification information from the radio tag 101 of a target animal that has entered the provided small room 12, but not to be able to receive identification information from the radio tag 101 of a target animal that has entered another small room 12. With this configuration, it is possible to determine which target animal has invaded which small room 12 based on identification information output from each radio tag receiver 20.

The terminal apparatus 60 performs a task for a target animal as described above. The terminal apparatus 60 controls the feeding device 121 to output a substance with high preference from the feeding device 121 according to a result of the task. The target animal that has completed the task can obtain the substance output from the feeding device 121.

Note that when a plurality of terminal apparatuss 60 are provided in the analysis supporting system 100, different tasks may be performed in some or all of the terminal apparatuss 60. For example, when a plurality of small rooms 12 are provided as shown in FIG. 3, different tasks may be performed for each terminal apparatus 60 provided in each small room 12.

In the analysis supporting system 100 configured in this manner, it is possible to identify each individual based on the individual information and then record the behavior history information of each target animal. For this reason, it becomes possible to evaluate animal behavior more appropriately using such behavior history information.

Furthermore, in the analysis supporting system 100, one or more types of analysis processing are performed in the analysis unit 733. Results of the analysis processing are recorded in the analysis information storage unit 723. For this reason, it becomes possible to more appropriately evaluate animal behavior using such analysis information.

The analysis supporting apparatus 70 does not necessarily need to be configured as a single device. For example, the analysis supporting apparatus 70 may be configured using a plurality of information processing devices. The plurality of information processing devices constituting the analysis supporting apparatus 70 may be communicably connected via a communication path such as a network, and may be configured as a system such as a cluster machine or a cloud.

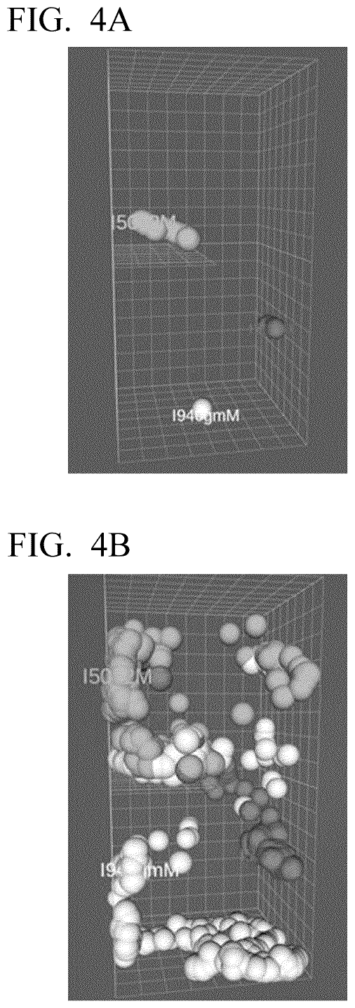

FIGS. 4A and 4B are diagrams which show results of analysis performed by the analysis supporting system 100 of the present invention. The analysis shown in FIGS. 4A and 4B takes, as an example, a situation in which three common marmosets are kept in the cage 11. FIG. 4A is an analysis diagram immediately after tracking the movement trajectory of each individual using this analysis supporting apparatus, FIG. 4B is an analysis diagram of a contact movement trajectory in which the movement trajectory of each individual was tracked for 5 minutes, and three different animals are shown in different colors. As a result of the analysis, an analysis of the preference of a place for one hour may be shown. In this case, symbols (for example, dots) indicating positions may be color-coded depending on a length of time for which each individual stays.

As described above, by evaluating the changes in behavior of each target individual over a life span of a target individual and a period of time in which changes over time in a target to be observed appear, it is possible to evaluate an onset of a disease from an early stage based on changes in behavior and preference. For example, by evaluating not only changes in behavior in dementia, but also changes in animal motivation and communication between individuals, it is also possible to evaluate effectiveness of specific drugs in the early stages of a disease and very early biomarkers for diagnosis.

Although the embodiments of the present invention have been described in detail above with reference to the drawings, a specific configuration is not limited to these embodiments, and includes designs and the like within a range not departing from the gist of this invention. For example, instead of the acceleration sensor 102 as described above, a sensor that obtains physiological information of a target animal or a barometer (an atmospheric pressure sensor) that measures an atmospheric pressure of a space where the target animal is present may be used as a wearable sensor. In this case, behavior history information may be configured as information indicating a history of physiological information, or may be configured as information indicating a history of measured values of atmospheric pressure. It is applicable to a technology that evaluates changes in behavior by observing animal behavior including social behavior of an animal over time.

### REFERENCE SIGNS LIST

100 Analysis supporting system
10 Cage
101 Radio tag
102 Acceleration sensor
111 Step
12 Small room
121 Feeding device
13 Passage
20 Radio tag receiver
30 Distance image sensor
40 Visible light image sensor
50 Acoustic sensor
60 Terminal apparatus
70 Analysis supporting apparatus
71 Communication unit
72 Storage unit
721 Individual information storage unit
722 Behavior history information storage unit
723 Analysis information storage unit
73 Control unit
731 Information recording unit
732 Individual tracking unit
733 Analysis unit
734 Individual information updating unit

1. An analysis supporting apparatus comprising:
an individual tracker configured to acquire behavior history information indicating a behavior history of each individual of a target animal, which is an animal to be analyzed, based on at least one piece of information among image information obtained by an image sensor that acquires an image of the target animal, acoustic information obtained by an acoustic sensor that acquires a sound emitted by the target animal, information obtained from a wearable sensor attached to the target animal, and information obtained from a terminal apparatus.

2. The analysis supporting apparatus according to claim 1,
wherein the wearable sensor is an acceleration sensor that obtains acceleration information of the target animal to which the wearable sensor is attached.

3. The analysis supporting apparatus according to claim 1,
wherein the individual tracker uses individual information stored in a storage unit to identify individuals in the used information, and to acquire the behavior history information for each identified individual.

4. The analysis supporting apparatus according to claim 1,
wherein information is presented to the target animal using a terminal apparatus and the behavior history information for each identified individual is acquired.

5. An analysis supporting method comprising:
acquiring at least one piece of information among image information obtained by an image sensor that acquires an image of a target animal, which is an animal to be analyzed, acoustic information obtained by an acoustic sensor that acquires a sound emitted by the target animal, information obtained from a wearable sensor attached to the target animal, and information obtained from a terminal apparatus; and
acquiring behavior history information indicating a behavior history of each individual of the target animal based on the acquired information of the target animal.

6. A computer program for causing a computer to function as the analysis supporting apparatus according to claim 1.
